(19) United States
(12) Patent Application Publication
(10) Pub. No.: US 2008/0133184 A1
(43) Pub. Date: Jun. 5, 2008

(54) Circle Spectrum Method in Analyzing Electrical Properties of Materials, Biological Tissues, Body, Devices, and Systems and its Applications in Medical Care, Industry, and Scientific Research, etc.

(76) Inventor: Zhihan Chen, Hudson, OH (US)

Correspondence Address: Yu Zhi, 2186 Weston Drive, Hudson, OH, 44236, US

(21) Appl. No.: 11/943,427

(22) Filed: Nov. 20, 2007

Related U.S. Application Data
(63) Continuation of application No. 60/866,629, filed on Nov. 21, 2006.

(51) Int. Cl. G06F 1/00

(52) U.S. Cl. 702/198

(57) ABSTRACT

A method to precisely differentiate the heavily overlapped electrical properties (electrical impedance or complex dielectric permittivity) measured from a system (a biological tissue, a body, a material, or a device, etc.).

### BACKGROUND OF THE INVENTION

The present invention is directed to a data analysis method for electrical properties of materials, biological tissues, devices, and systems. It greatly improves the accuracy of electrical data analyses, yielding more reliable explanations of the electrical properties. This invention is further directed to a derivative, angular, logarithmic circle spectrum analysis method; using this method, a concrete relationship between the electrical properties of a complex system, material, biological tissue, or device and its individual structure/component can be established. This has wide applications in medical care, industry, and scientific research.

Complex-impedance spectroscopy and complex-permittivity spectroscopy are widely used in measuring and analyzing electrical properties of various materials, devices, and systems, which are of both great fundamental and practical importance in many fields. For example, by measuring electrical properties of human burned skin, researchers can monitor its healing process. This has been described in detail in “Free water content and monitoring of healing process of skin burns studied by microwave dielectric spectroscopy in vivo” by Y. Hayashi, N. Miura, N. Shinyashiki, and S. Yagihara, Physics in Medicine and Biology, 50, 599 (2005). In addition, changes in the electrical properties of skin can provide an early warning of breast cancer; this initiated the development of electrical breast cancer mammography. In fact, electrical properties of biological tissues have been extensively studied for over one hundred years, whose results found wide applications, such as electromagnetic dosimetry, electrical computed tomography (or say electrical impedance tomography, EIT), and diagnostic systems in medical care (see “Applied potential tomography”, by D. C. Baber and B. H. Brown, J. Phys. E: Sci. Instrum., 17, (1984) 723; and “Three-dimensional electrical impedance tomography”, by P. Metherall, D. C. Barber, R. H. Smallwood and B. H. Brown, Nature, 380 (6574), (1996) 509).

For example, Electrical computed tomography (E-CT) is a medical imaging technique in which an image of the conductivity or permittivity of a part of the body is inferred from surface electrical measurements. The electrical potential is measured by applying small alternating currents to the skin of the body via conducting electrodes attached to the skin. Then the electrical data are used to reconstruct the configuration of the conductivity (or permittivity). This is a non-linear inverse problem and is severely ill-posed (see, http://en.wikipedia.org/wiki/Electrical_impedance_tomography).

E-CT is much cheaper and safer than the current widely used X-ray computed tomography (X-CT), but suffers from its much lower resolution, which is why E-CT has not been widely used in clinics.

Up to date, the main effort to improve the resolution of E-CT has been focused on improving the algorithms for image reconstruction based on obtained electrical data or improving the measuring accuracy of the equipment/facility. There are a number of patents on these aspects. For example, U.S. Pat. No. 5,588,429 to Isaacson et al., describes a process (method) to produce optimal current patterns for electrical impedance tomography. U.S. Pat. No. 5,284,142 to Goble et al., outlines a three-dimensional impedance imaging process. U.S. Pat. No. 5,390,110 to Cheney, et al., involves a method of layer stripping for impedance imaging. But much less effort has been made to precisely analyze the electrical data first, and then use suitable algorithms to reconstruct the image.

If electrical signals detected by the E-CT from body (or tissues) can be precisely differentiated and related to the structure and components of body (or the tissue), it would be very helpful in improving the resolution of Electrical Computed Tomography (E-CT). In fact, the same difficulty exists in the applications of E-CT in industry for the purpose of processing monitoring.

E-CT also has potential applications in monitoring industrial process, such as the flow of fluids in pipes, the concentration of one fluid in another, and the distribution of a solid in fluid, etc., by measuring the complex-permittivity distribution in the interior of a system (see, W. Q. Yang, M. S. Beck, M. Byars, Electrical capacitance tomography: from design to applications, Measurement Control, 28, (1995) 261). It is also used in geophysics for imaging sub-surface structures from electrical measurements made at the surface, or by electrodes in one or more boreholes.

Complex-Impedance Spectroscopy (CIS) operates by sending an electrical current and measuring the correspondent electrical signal. This data can then be modeled on an equivalent circuit consisting of one or more parallel RC elements (a resistor with resistance R parallel with a capacitor with capacitance C) connected in series (see, E. Barsoukov, J. R. Macdonald, Impedance spectrum, 2^{nd} Ed., John Wiley & Sons, New York, 2005). Each RC circuit reflects a component or structure. Each complex-impedance for an RC element is expressed by,

Z*=Z′−jZ″=R/[1+jωτ] (1)

where ω is angular frequency, τ=RC is time constant, and j²=−1, real part Z′=R/(1+ω²C²R²), imaginary part Z″=ωCR²/(1+ω²C²R²). Therefore, the Z′˜Z″ plot is an ideal semicircle in the complex plane due to Z′, Z″>0, and follows an equation, (Z′−x₀)²+Z″²=r², where (x₀,0) is the coordination of the center of the semicircle and located on the Z′ axis, and x₀=(Z′ₛ+Z′_{∞})/2, r=(Z′ₛ−Z′_{∞})/2, with Z′ₛ and Z′_{∞} being the intercepts at the Z′ axis.

In 1928, Kenneth Cole found that the semicircle's center of the Z′˜Z″ plot of human skin lies below the Z′ axis, and Eq.(1) should be rewritten as,

Z*=R/[1+(jωτ)^{1-α}] (2)

where α is a constant between 0and 1.

Complex-Permittivity Spectrum (CPS): Dielectric relaxation is widely observed in biological tissues; a dielectric relaxation process can be described by the Debye model in complex-permittivity (ε*) representation (see, E. Barsoukov, J. R. Macdonald, Impedance spectrum, 2^{nd} Ed., John Wiley & Sons, New York, 2005):

ε*=ε′−j ε″=ε_{∞}−(εₛ−ε_{∞})/[1+jωτ] (3)

where τ is a relaxation time, ω is the angular frequency, ε_{∞} is the permittivity at ωτ>>1, εₛ is the permittivity at ωτ<<1, and Δε=εₛ−ε_{α} is the dielectric polarization strength. Eq.(3) represents an ideal semicircle with center on the ε′ axis in the ε*=ε′−j ε″ complex-plane.

Similar to that of CIS, Kenneth Cole and Robert Cole reported in 1941 (see, K. S. Cole and R. H. Cole, dispersion and absorption in dielectrics, I. Alternating current characteristics, Journal of Chemical Physics, 9, 341 (1941).) that the centers of semicircular-arc plot of ε″ vs. ε′ in materials mostly lies below the ε′ axis; hence, Eq. (3) should be rewritten as:

ε*=ε_{∞}+Δε/[1+(jωτ)^{1-α}] (4)

This empirical equation, known as the “Cole-Cole” plot, has been extensively used since then.

Difficulty for both CIS and CPS: In practical cases, CIS or CPS is generally a sum of several semicircles with centers below the real axis. This becomes more complicated when relaxation times τ of each semicircle are close in value; that is, CIS or CPS is a combination of heavily overlapped semicircles. In fact, a measurement provides us a sum of all semicircles. Equations for describing it should be,

Z*=Σ Rₙ/[1+(jωτₙ)^{1-α}ₙ] (5)

and

ε*=ε_{∞}+Σ Δεₙ/[1+(jωτₙ)^{1-α}ₙ]+σ/jωεₒ (6)

In Eq.(6), a term of conductivity is added to account for possible ionic conduction. For the analysis of the data, a key issue is how to properly and precisely differentiate each individual semicircle of CPS and CIS.

However, in the current literature, CIS or CPS spectrum cannot be precisely decomposed, especially when arcs are heavily overlapped. Unfortunately, these phenomena are so common that applications of CIS or CPS are severely limited.

### Obstacles Encountered in the Complex-Impedance/Permittivity Spectra

Mathematically speaking, Eqs. (2) & (4) for the complex impedance and complex permittivity represent a semicircle in the complex plane, and Eqs. (5) & (6) represent a sum of many semicircles in the complex plane. In practical cases, such as in a biological tissue, generally more than one tissue component/structure exist, each component/structure corresponds to a relaxation process, whose electrical property is displayed as a semicircle—like arc in the complex-impedance and complex-permittivity plane; therefore the graph of electrical property of biological tissues is composed of several semicircle—like arcs in the complex-impedance and complex-permittivity plane. The graph is further complicated when the relaxation times τ of each component/structure or relaxation process are close in value, since arcs then overlap heavily.

The overall electrical property, i.e., the complex-impedance and complex-permittivity spectra, of a complex system (a biological tissue, or an electrical material, or a device, etc.) is generally comprised of contributions from many individual components/structure of the system. In order to obtain good understanding of the measured system, we need to distinguish the individual contribution of each component/structure of the system. In fact, if the sources of the semicircular arcs can be correctly differentiated for the complex-impedance and complex-permittivity data of a system, electrical parameters εₛ, ε_{∞}, Δε, τ, etc. for each individual component/structure can be obtained. Then, it is possible for us to precisely reconstruct the configuration of the conductivity (or permittivity) based on the complex-impedance and complex-permittivity data, which are obtained from surface measurements of current and potential.

Therefore, the differentiation and the precise fitting of complex-impedance and/or complex-permittivity data become a challenging but highly desirable pursuit. In current literature, complex-impedance and/or complex-permittivity data cannot be properly decomposed and analyzed when arcs are heavily overlapped or too short. Unfortunately, these phenomena are so frequent that wide applications of the complex impedance spectroscopy and complex permittivity spectroscopy are severely limited.

Up to now, in the field of electrical properties of biological tissues, one of the most widely used and cited analysis results was reported by Dr. S. Gabriel et al. (see, C. Gabriel, S. Gabriel, and E. Corthout, The dielectric properties of biological tissues. 1. Literature survey, Physics in Medicine and Biology, 41 (11): (1996) 2231; S. Gabriel, R. W. Lau and C. Gabriel, The dielectric properties of biological tissues. 2. Measurements in the frequency range 10 Hz to 20 GHz, Physics in Medicine and Biology, 41 (11): (1996) 2251; S. Gabriel, R. W. Lau and C. Gabriel, The dielectric properties of biological tissues. 3. Parametric models for the dielectric spectrum of tissues, Physics in Medicine and Biology, 41 (11): (1996) 2271). Gabriel et al. analyzed the electrical properties of more than forty biological tissues, which they measured in the frequency range of 10 Hz-20 GHz, in terms of multiple Cole-Cole dispersions, i.e., Equation (6). Their fittings comprise of several Cole-Cole semicircles, an infinite-frequency ε_{∞} and conductivity σᵢ. The data are posted on the websites of the US Air Force and The Institute for Applied Physics, Italian National Research Council (see, S. Gabriel, Compilation of the dielectric properties of body tissues at RF and microwave frequencies, U.S. Brooks Air Force Technical Report, AL/OE-TR-1996-0037. The data and figures are posted on the website: http://www.brooks.af.mil/AFRL/HED/hedr/reports/dielectric/home.html, and the website of the Institute for Applied Physics (IAP), Italian National Research Council, http://niremf.ifac.enr.it/tissprop/).

However, it was found that there are significant deviations between the measured data and the theoretical analysis results. These can be seen from examples by Gabriel et al. In addition, the serious problem resulting from the large deviations is that the analysis results hold no real biological meaning, but it is an essential goal for researching the electrical properties of biological tissues, especially for the practical applications in the field of medical care, for example, E-CT (or say EIT). Dr. Gabriel admitted that “taken as a whole this model should not be used to correlate the dielectric parameters to the structure and composition of the various tissues.”

### Difficulty in Improving Resolution of E-CT

As mentioned above, one of the very promising applications of the complex impedance spectroscopy and complex permittivity spectroscopy is E-CT and diagnostic system in medical care and industrial process monitoring. For example, E-CT is much cheaper and safer than the currently used X-ray CT, but suffers from its much lower resolution, which seriously limits its applications potential. If electrical signals detected from body (or biological tissues) can be precisely differentiated and related to the individual structure/components of body, it would be very helpful in improving the resolution of E-CT. In fact, the same difficulty exists in the applications of E-CT in industry for the purpose of processing monitoring and the geophysics for imaging sub-surfaces structures.

### SUMMARY OF THE INVENTION

The present invention is the development of a derivative/logarithmic/angular circle spectrum analysis method, which greatly improves the accuracy of electrical data analyses, yielding reliable explanations of the electrical properties of materials, biological tissues, devices, and systems; hence, a concrete relationship between the overall electrical properties and the structure/component of the material, biological tissue, device or system can be established.

This is achieved by the following steps:
(1) converting the electrical properties of a system (materials, biological tissues, body, devices, etc.) into complex-permittivity (real and imaginary part ε′ and ε″) and complex-impedance (real and imaginary parts Z′ and Z″) data;
(2) converting and plotting the ε′ versus ε″, and Z′ versus Z″ data into log ε″-log ε′, and log Z″-log Z″ data, i.e., logarithmic-logarithmic scale (spectrum).
(3) converting and plotting the ε′ versus ε″, and Z′ versus Z″ data into the slope dε″/dε′ versus ε′, and dZ″/dZ′ versus Z′ data, i.e., derivative circle spectrum.
(4) converting and plotting the ε′ versus ε″, and Z′ versus Z″ data into θ (tan θ=−dε″/dε′) versus ε′, and θ (tan θ=−dZ″/dZ′) versus Z′ data, i.e., angular circle spectrum.
(5) Using a numerical fitting program (for example, a commercial software, Excel) to fit the derivative circle spectrum and/or angular circle spectrum for both CPS and CIS, according to Eq. (5) and (6).

Also plotting the fitting results in a log-log scale for additional confirmation in accuracy, then the electrical parameters can be obtained.
(6) based on the parameters obtained from both CPS and CIS, we can obtain useful information and a reasonable interpretation of the electrical properties of a system.

The application of this method to biological tissues, such as human skin and ovine blood, confirms its effectiveness, i.e., it provides much more accurate analyses and predictions. Most significantly, the results now hold reliable biological interpretations.

This indicates that this method is very useful in many applications, such as in the diagnostic and monitoring systems for medical care, industry and scientific research.

### BRIEF DESCRIPTION OF THE DRAWINGS

FIG. 1 Linear, logarithmic, and derivative circle standard spectra of (a) Complex Permittivity Spectrum (CPS) with a combination of four ε″˜ε40 semicircles; (b) Complex Impedance Spectrum (CIS) with a combination of five Z″˜Z′ semicircles. Solid curves: each semicircle representing an equivalent circuit corresponding to a component of tissue; and open dots: combining/sum result of the semicircle.

FIG. 2(a) Frequency dependence of dielectric constant (ε′) and conductivity (σ′); (b) Cole-Cole plot in log ε″-log ε′ scale; inset: linear Cole-Cole plot; and (c) derivative circle spectrum (dε″/dε′ vs. ε′) of dry human skin at 37° C.

FIG. 3(a) Frequency dependence of dielectric constant (ε′) and conductivity (σ′); (b) Cole-Cole plot in log ε″-log ε′ scale; inset: linear Cole-Cole plot; and (c) derivative circle spectrum (dε″/dε′ vs. ε′) of ovine brood at 37° C.

FIG. 4(a) Frequency dependence of dielectric constant (ε′) and conductivity (σ′); (b) Cole-Cole plot in log ε″-log ε′ scale; inset: linear Cole-Cole plot; and (c) derivative circle spectrum (dε″/dε′ vs. ε′) of bovine liver.

FIG. 5(a) Frequency dependence of dielectric constant (ε′) and conductivity (σ′); (b) Cole-Cole plot in log ε″-log ε′ scale; inset: linear Cole-Cole plot; and (c) derivative circle spectrum (dε″/dε′ vs. ε′) of bovine heart.

FIG. 6(a) Frequency dependence of dielectric constant (ε′) and conductivity (σ′); (b) Cole-Cole plot in log ε″-log ε′ scale; inset: linear Cole-Cole plot; and (c) derivative circle spectrum (dε″/dε′ vs. ε′) of wet human skin.

FIG. 7(a) Frequency dependence of dielectric constant (ε′) and conductivity (σ′); (b) Cole-Cole plot in log ε″-log ε′ scale; inset: linear Cole-Cole plot; and (c) derivative circle spectrum (dε″/dε′ vs. ε′) of bladder-bile.

FIG. 8(a) Frequency dependence of dielectric constant (ε′) and conductivity (σ′); (b) Cole-Cole plot in log ε″-log ε′ scale; inset: linear Cole-Cole plot; and (c) derivative circle spectrum (dε″/dε′ vs. ε′) of cerebral spinal fluid.

FIG. 9(a) Frequency dependence of dielectric constant (ε′) and conductivity (σ′); (b) Cole-Cole plot in log ε″-log ε′ scale; inset: linear Cole-Cole plot; and (c) derivative circle spectrum (dε″/dε′ vs. ε′) of vitreous humor.

FIG. 10 Table 1: The fitting parameters obtained from eight biological tissues by CPS and CIS, including four liquid-like tissues and four solid-like tissues.

FIG. 11(a) Linear complex-impedance (Z″ vs. Z′) plot, (b) log Z″ vs. log Z′ plot, and (c) derivative circle plot dZ″/dZ′ vs. Z′) of the dry human skin at 37° C.

FIG. 12(a) Linear complex-impedance (Z″ vs. Z′) plot, (b) log Z″ vs. log Z′ plot, and (c) derivative circle plot dZ″/dZ′ vs. Z′) of the ovine blood at 37° C.

FIG. 13(a) Linear complex-impedance (Z″ vs. Z′) plot, (b) log Z″ vs. log Z′ plot, and (c) derivative circle plot dZ″/dZ′ vs. Z′) of the bovine liver.

FIG. 14(a) Linear complex-impedance (Z″ vs. Z′) plot, (b) log Z″ vs. log Z′ plot, and (c) derivative circle plot dZ″/dZ′ vs. Z′) of the bovine heart.

FIG. 15(a) Linear complex-impedance (Z″ vs. Z′) plot, (b) log Z″ vs. log Z′ plot, and (c) derivative circle plot dZ″/dZ′ vs. Z′) of the wet human skin.

FIG. 16(a) Linear complex-impedance (Z″ vs. Z′) plot, (b) log Z″ vs. log Z′ plot, and (c) derivative circle plot dZ″/dZ′ vs. Z′) of the bladder-bile.

FIG. 17(a) Linear complex-impedance (Z″ vs. Z′) plot, (b) log Z″ vs. log Z′ plot, and (c) derivative circle plot dZ″/dZ′ vs. Z′) of the cerebral spinal fluid.

FIG. 18(a) Linear complex-impedance (Z″ vs. Z′) plot, (b) log Z″ vs. log Z′ plot, and (c) derivative circle plot dZ″/dZ′ vs. Z′) of the vitreous humor.

### DETAILED DESCRIPTION OF THE INVENTION

The present invention is developing a novel data analysis method for electrical properties of materials, biological tissues, devices, and systems, that is, a derivative/angular/logarithmic circle spectrum analysis method, which greatly improves the accuracy of data analyses, yielding reliable explanations of the electrical properties.

### Our Solution: Derivative/Angular/Logarithmic Circle Spectrum

This invention begins with studies of circles and their properties, from which we have developed an innovative approach: the Derivative/Logarithmic Circle Spectra method, an analysis particularly useful in complex-impedance and complex-permittivity spectra study.

The general mathematical description of a circle is:

(x−x₀)²+(y−y₀)²=r² (7)

where (x₀, y₀) denotes the center and r is the radius.

The slope of a circle can be mathematically derived:

dy/dx=−(x−x₀)/(r²−(x−x₀)²)^{1/2} (8a)

On the other hand, we can calculate the slope values using the experimental data of two points (x₁, y₁) and (x₂, y₂) with:

dy/dx32 Δy/Δx=(y₂−y₁)/(x₂−x₁) (8b)

Then we can draw a plot of dy/dx versus x. Based on two points on the curve of dy/dx versus x, we can solve for r and x₀ values according Eq.(8a). In addition, from Eq.(8a), we have,

dy/dx=−(x−x₀)/(y−y₀) (8c)

then we can calculate y₀. Thus, we can obtain all information of a circle based on two derivative points. This is an improvement over Eq.(8), where three points are needed in order to determine a circle.

We found that an unique advantage of a derivative (slope) circle spectrum, dy/dx˜x, is its ability to display the overall data on a small scale, regardless of the size of semicircles; for example, dy/dx values from −5.7 to 5.7 cover polar angles from ˜−80° to 80°, which is 89% of a semicircle. Most importantly, due to this behavior, the derivative circle spectrum possesses very high sensitivity and accuracy. This is confirmed by the examples to be presented below.

A slope dy/dx can be also converted to an angle θ since dy/dx=tanθ, where θ is the polar angle of a point on a semicircle, and the value of θ ranges from −90 to 90° for all semicircles. In fact, the polar angle θ ˜ε′ (or Z′) plot is also able to show the whole picture in the [−90, 90] range, and can be easily obtained from any circle. Therefore, the θ ˜ε′ (or Z′) plot can be used as an additional representation for the fit.

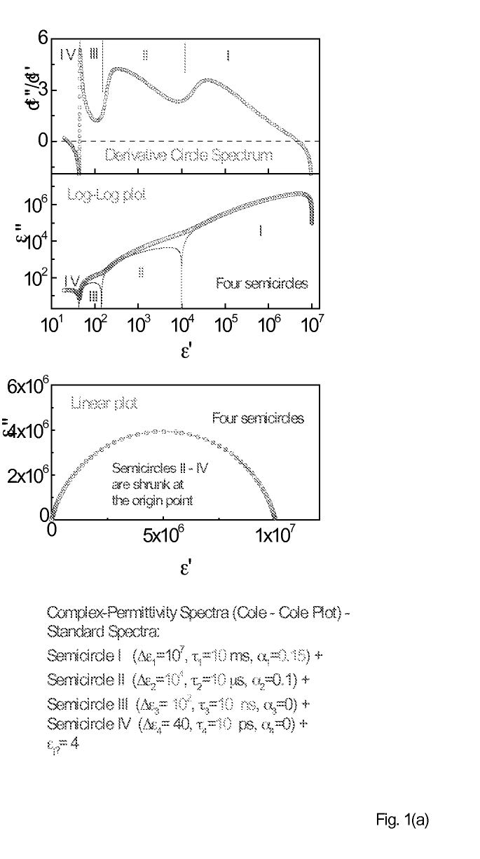

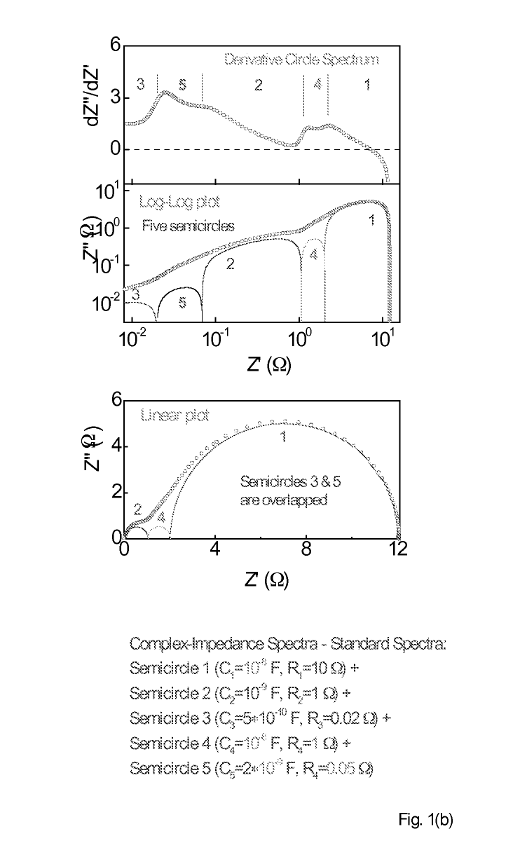

We also found that plotting the complex-impedance in a logarithmic-logarithmic coordinate, i.e., log y vs. log x, offers great benefits in identifying the number of semicircles because log magnifies smaller components of the graph while shrinking bigger components, providing an overall picture that ascertains the existence of small circles indiscernible on a linear graph. FIG. 1(a) and (b) depict two typical CPS and CIS plots. High sensitivity of the derivative circle spectrum and the ability of logarithmic circle spectrum depicting whole picture of plot can be clearly seen. The minor semicircles or small scaled components are significantly revealed in a log-log spectrum and further in a derivative spectrum. In the following, we show some examples analyzed by Derivative/Logarithmic Circle Spectra method.

### Application to Biological Tissues

### Complex-Permittivity Spectrum (CPS)

### EXAMPLE 1

### Human Dry Skin: Using our Analysis Methods (Log-Log Spectrum and Derivative Circle Spectrum) for CPS

In 1996, Gabriel et al reported the electrical properties of 45 biological tissues up to 20 GHz, which is currently one of the widely used data (see, C. Gabriel, S. Gabriel, and E. Corthout, The dielectric properties of biological tissues 1. Literature survey, Physics in Medicine and Biology, 41 (11): (1996) 2231; S. Gabriel, R. W. Lau and C. Gabriel, The dielectric properties of biological tissues 2. Measurements in the frequency range 10 Hz to 20 GHz, Physics in Medicine and Biology, 41 (11): (1996) 2251; S. Gabriel, R. W. Lau and C. Gabriel, The dielectric properties of biological tissues 3. Parametric models for the dielectric spectrum of tissues, Physics in Medicine and Biology, 41 (11): (1996) 2271). We will analyze the experimental data using our method. In addition, Gabriel et al also presented their analyzed results of the data in terms of Eq. (6), which are compared to our fitting results.

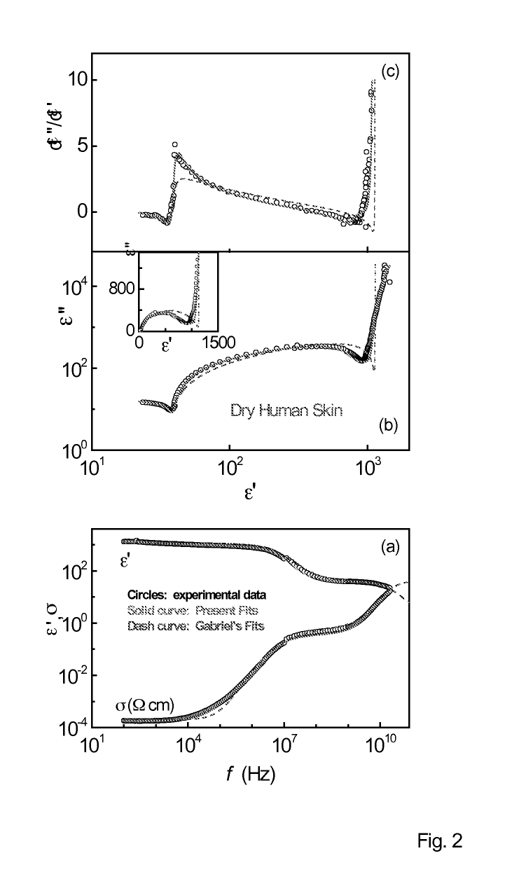

Gabriel et al.'s experimental data and fitting results (downloaded from the website of U.S. Brooks Air Force and The Institute for Applied Physics, Italian National Research Council: http://www.brooks.af.mil/AFRL/HED/hedr/reports/dielectric/home.html, and http://niremf.ifac.enr.it/tissprop/) of dielectric constant (ε′) and conductivity (σ) of human dry skin at 37° C. are re-plotted in FIG. 2(a).

Although they employed the Cole-Cole equation to fit the data, the results are graphed on a permittivity/conductivity vs. frequency profile (Gabriel et al. used two semicircles, semicircle I: Δε₁=32.0, τ₁=7.23 ps, α₁=0; semicircle II: Δε₂=1100, τ₂=32.48 ns, α₂=0.20; combining with ε_{∞}=4.0 and σ=0.0002 S/m). Now let us convert the results into a Cole-Cole plot, as shown in the inset of FIG. 2(a); we found that the linear plot fails to depict a complete picture of the data, because the small values of data are shrunken and being almost overlapped at the original point in the coordinate. Using the log-log scale, an overall picture of whole data range can be clearly seen in FIG. 2(b). It shows that there are at least three regions, the first one at low ε′ values less of than 40, the second one with ε′ between 40 and ˜1000, and the third with ε′ larger than ˜1000. Furthermore, the derivative circle spectrum shown in FIG. 2(c) reveals more than one slope in the second region when compared with the standard derivative circle spectra; we found that three semicircles should be considered for the second region. Therefore, five semicircles (one for the first region, three for the second region, one for the third region) combined with ε_{∞ and σ}ᵢ are necessary to account for an excellent description of the experimental data.

The fitting results are shown by solid curves in FIG. 2, and the parameters are listed in Table 1. The improvement of the present fit compared with those by Gabriel et al. is significant.

### EXAMPLES 2-8

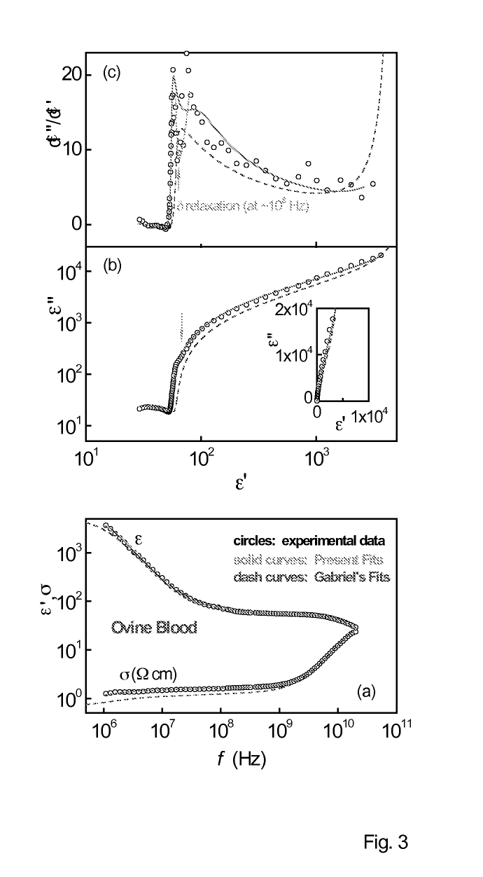

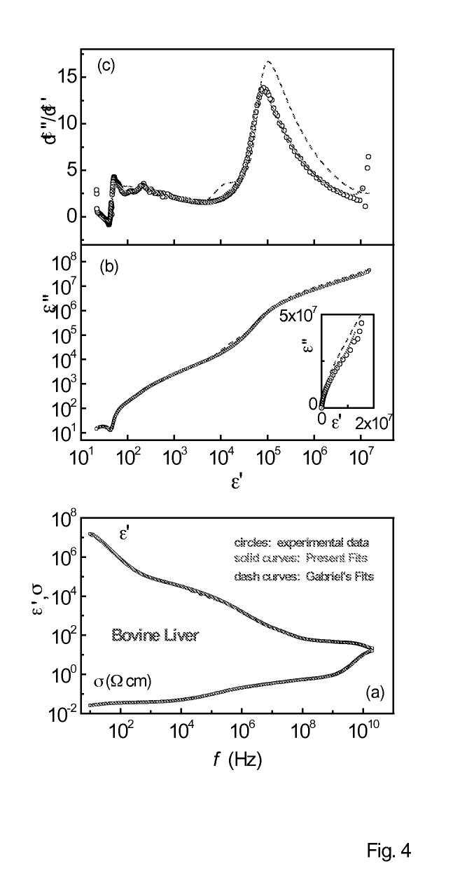

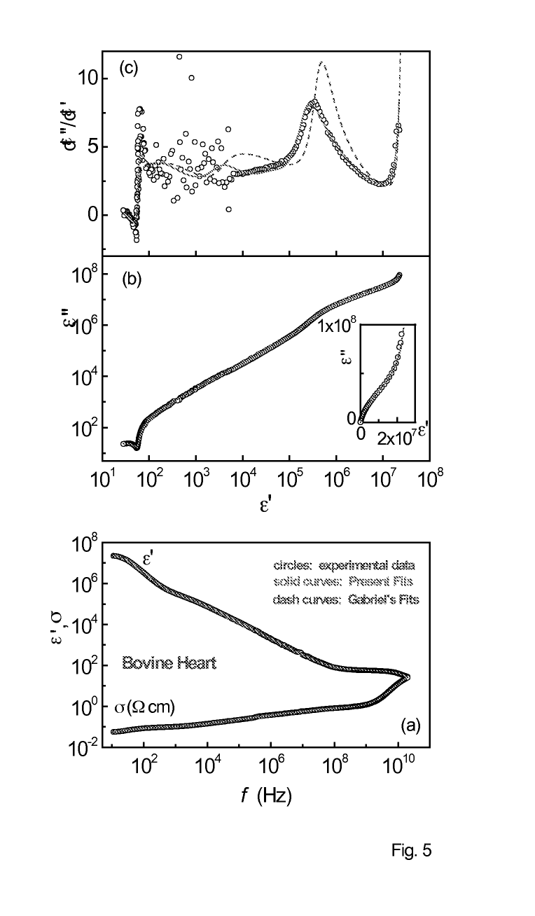

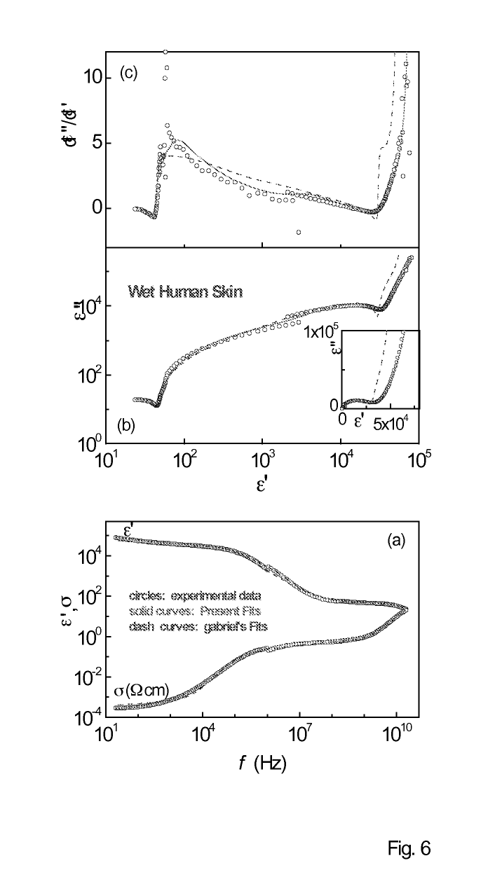

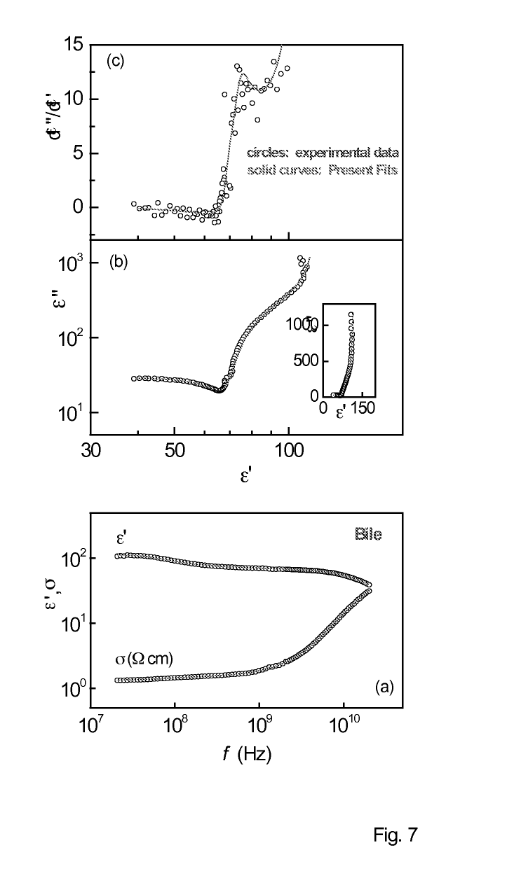

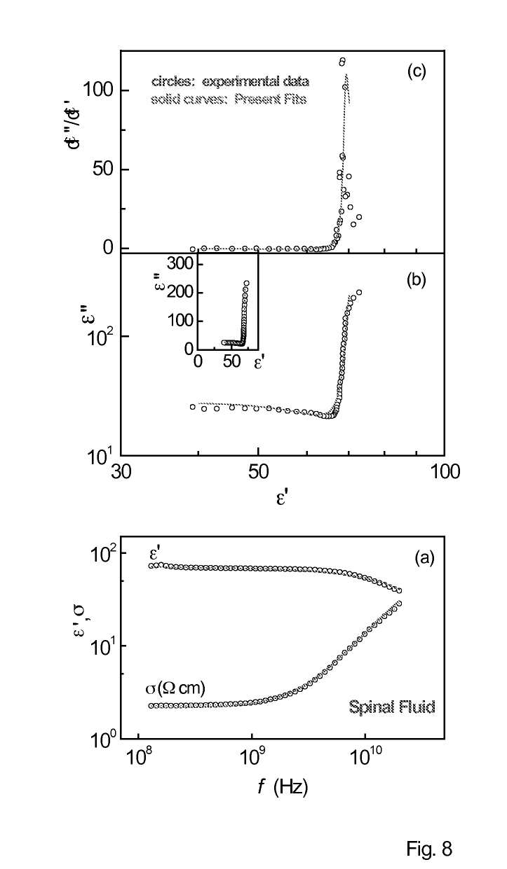

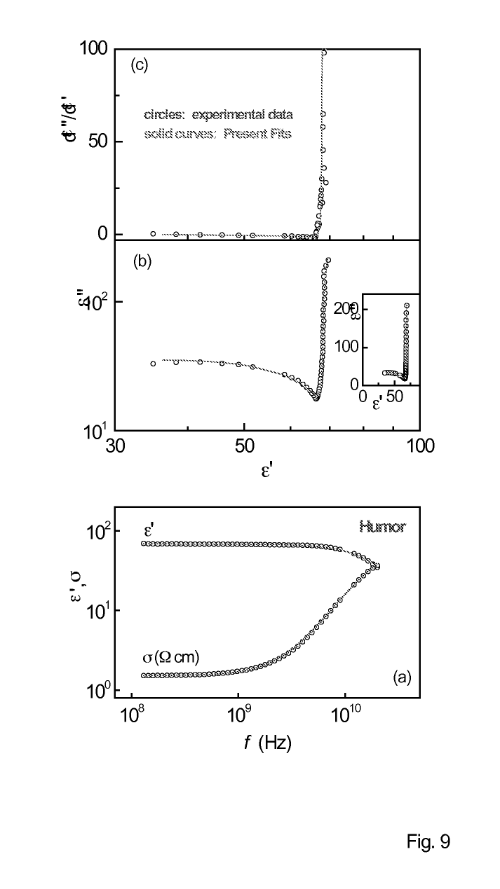

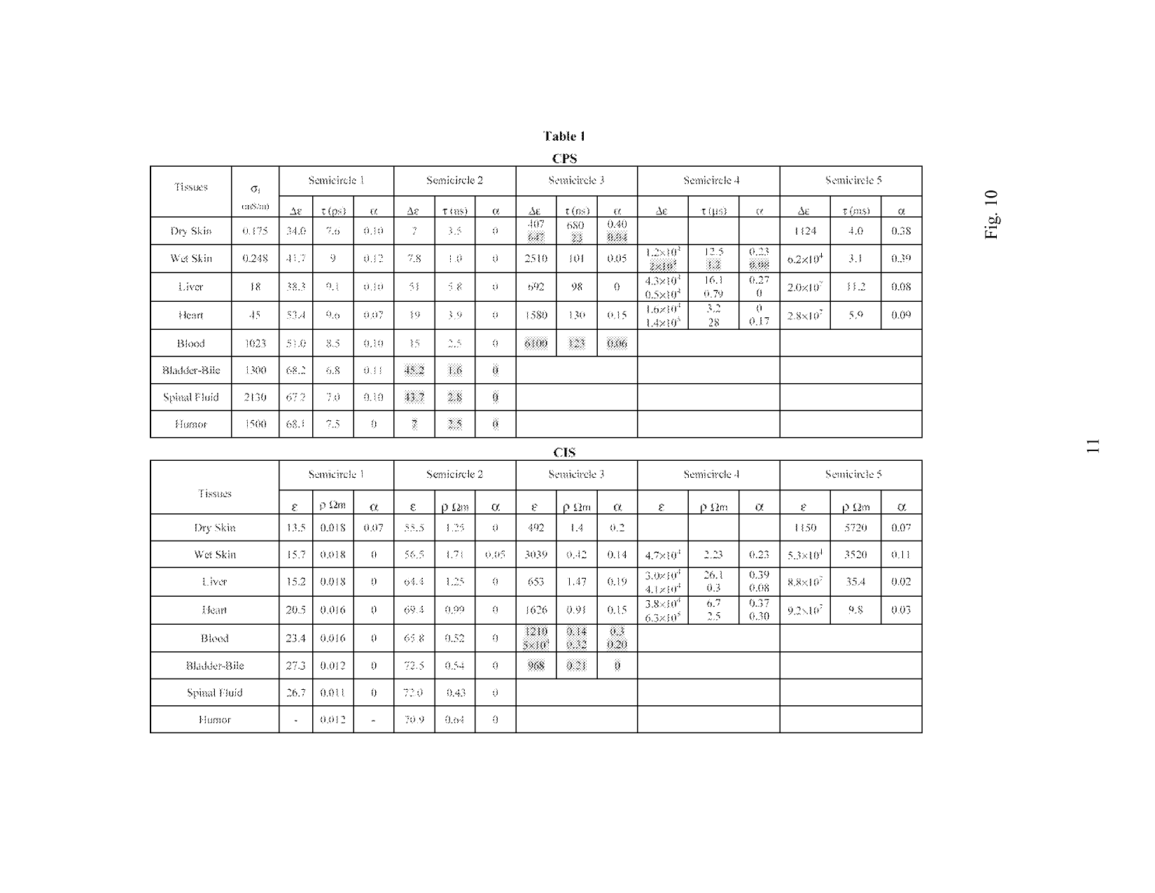

The examples 2-8 are results obtained using our methods for analyzing the electrical properties of ovine blood, ovine liver, bovine heart, wet human skin, bladder-bile, cerebral spinal-fluid, and vitreous humor; the fitting results are plotted in FIGS. 3-9. The fitting results obtained by Gabriel et al. ' method are also plotted for comparison. It can be seen that all the fits using our method provide excellent agreement with the experimental data. The parameters are listed in Table 1 shown in FIG. 10.

Discussion for CPS results: In the current literature, CPS of tissues doesn't provide clear biological interpretations in many cases. In their widely cited article (see, S. Gabriel, R. W. Lau and C. Gabriel, The dielectric properties of biological tissues 3. Parametric models for the dielectric spectrum of tissues, Physics in Medicine and Biology, 41 (11): (1996) 2271), Gabriel et al. stated that “taken as a whole this model should not be used to correlate the dielectric parameters to the structure and composition of the various tissues.” However, the highly accurate fits using the present method provides a possibility to obtain reliable biological interpretations of CPS. We discuss below the interpretations of semicircles listed in Table 1 (shown in FIG. 10):

(1) Semicircle 1: The dielectric relaxation with the relaxation time of picosecond level τ₁=6.8-9.6 ps (corresponding to ˜20 GHz), Δε₁=34.0-68.2, and α₁=0-0.12, can be attributed to the biological water of the tissues, which is the γ relaxation reported in the literature.

We should emphasize that the present fit give high accuracy results, for example, the ovine blood has Δε₁=51, which corresponds to the Gabriel et al.'s semicircle I with Δε_{I}=56, but there is ˜10% difference. The precise As values we have obtained are significant because water content of tissues can be calculated based on Δε values.

(2) Semicircle 2: The relaxation has relaxation time of nano-second level τ₂=1.0-5.8 ns (˜10⁸ Hz), Δε₂=7-51, and α₃=0. This one is often neglected in the current literature due to its small Δε value; for instance, Gabriel et al.'s fits did not report this relaxation. But its existence is clearly shown in the derivative circle spectrum. For example, a sharp drop with Δε=˜15 at ˜10⁸ Hz in ovine blood can be seen in FIG. 3(c). This relaxation can be attributed to the so-called “δ dielectric relaxation,” which was first observed and referred to as water bounded with proteins and/or the polarization of side-chains of proteins by Schwan (See, H. P. Schwan, Electrical properties of blood and its constituents: alternating current spectroscopy, Blut, 46, (1983) 185-197). This explanation can perhaps be extended to other tissues. The existence of the δ relaxation in other tissues can be seen by a deep drop in the derivative circle spectrum at ˜10⁸ Hz.

Semicircle 3: This relaxation process around 1 MHz is known as β relaxation in the literature, which is generally recognized to be caused by the capacitive charging of cellular membranes. For example, the blood has parameters: Δε₃=6100, τ₃=0.12 μs (˜1.3 MHz), and α₃=0.06; based on these data, and according to Eq.(54a) in the article (see, K. R. Foster and H. P. Schwan, Dielectric properties of tissues and biological materials: a critical review, Critical Reviews in Biological Engineering, 17, (1989) 25), we take the radius of the red blood cells of 7 μm, volume fraction p=0.45 (the volume fraction of red blood cells in the normal blood is ˜45%), then substitute Δε=˜6100 into the equation, we obtain the membrane capacitance Cₘ of red blood cells (major cell in blood) being of 7.6×10⁻³ F/m². This is in agreement with the value of ˜8×10⁻³ F/m² for cellular membranes in the literature.

Semicircle 4: We name this polarization at radio frequency around or less than ˜100 kHz, as β′ relaxation.

Semicircle 5: This polarization at audio-frequency is known as α relaxation in the literature (see, K. R. Foster and H. P. Schwan, Dielectric properties of tissues and biological materials: a critical review, Critical Reviews in Biological Engineering, 17, (1989) 25).

Our fits also gave the dc conductivity of tissues σᵢ=0-2.1 S/m and the remaining dielectric constant ε_{∞}=4 at ˜10¹² Hz.

### Complex-Impedance Spectrum (CIS):

CIS was used at the earlier stage of the study of the electrical properties of tissues in 1920s. But it is not as widely used in current literature as CPS. We show below that CIS analyzed by the present method can provide very important and useful information.

### EXAMPLE 9

### Human Dry Skin: Using our Analysis Methods (Log-Log Spectrum and Derivative Circle Spectrum) for CIS

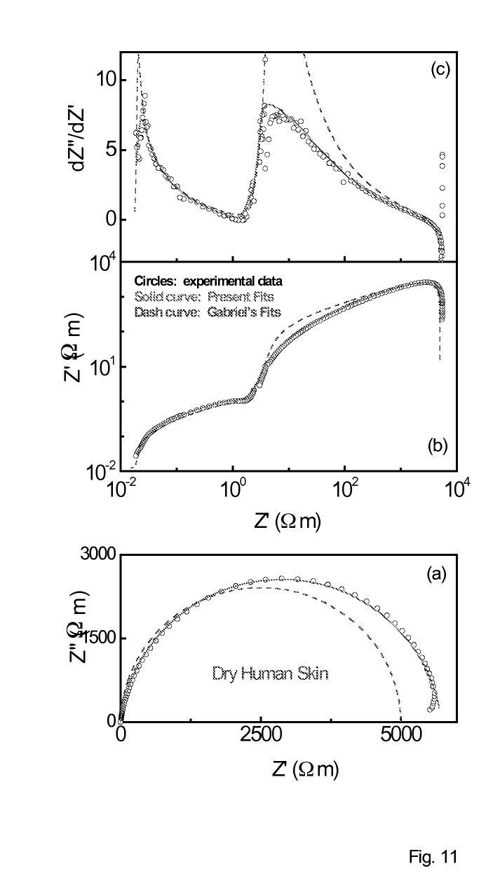

The experimental data and fitting results by Gabriel et al. for human dry skin are converted to the complex-impedance data, shown in FIG. 11(a). In this representation, even in the linear plot, the deviation of the fits from the data is obvious. Fitting the data in terms of derivative circle spectrum yields excellent agreement, as shown in FIG. 11(b).

### EXAMPLES 10-16

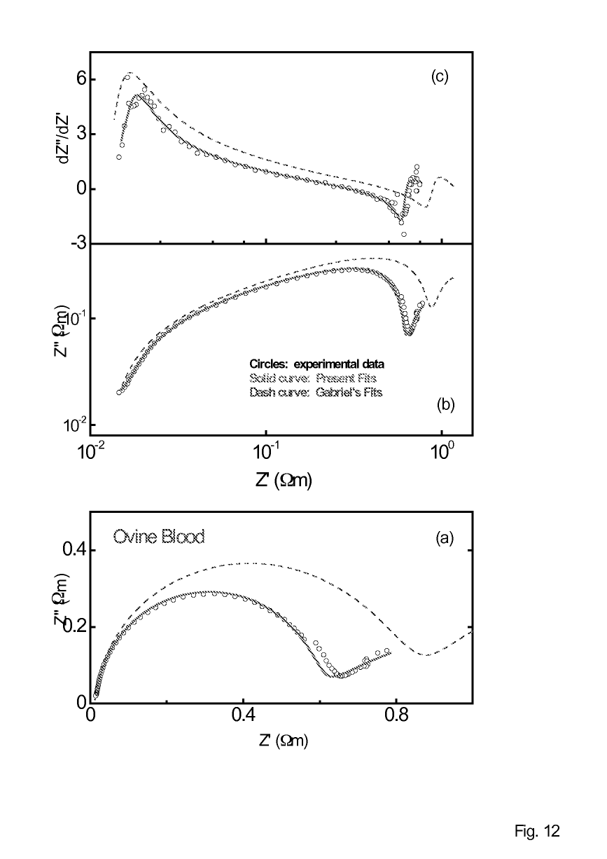

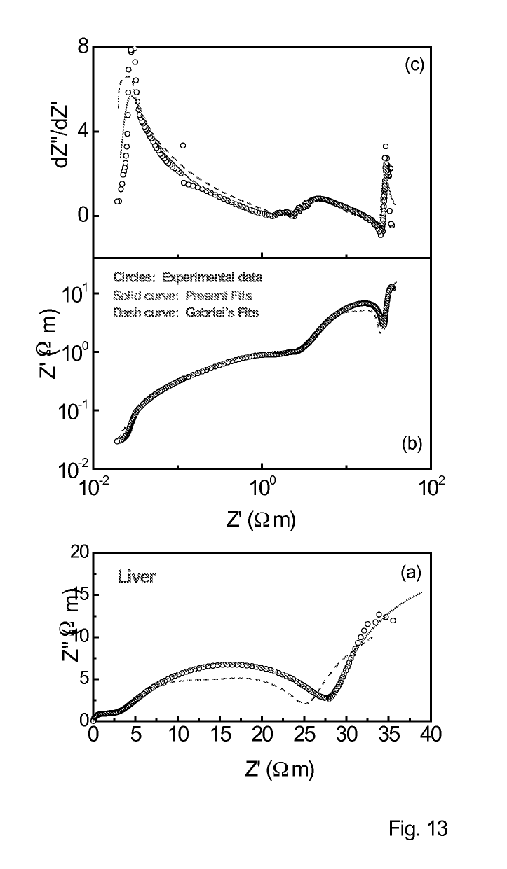

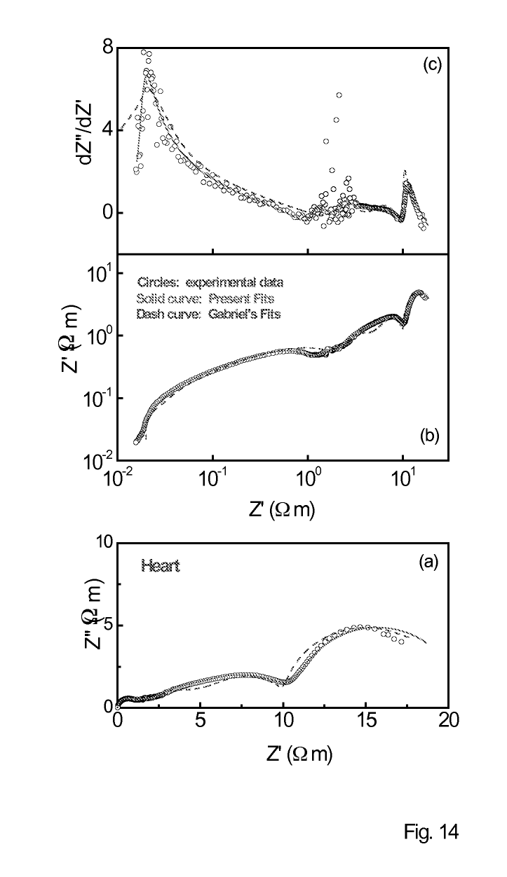

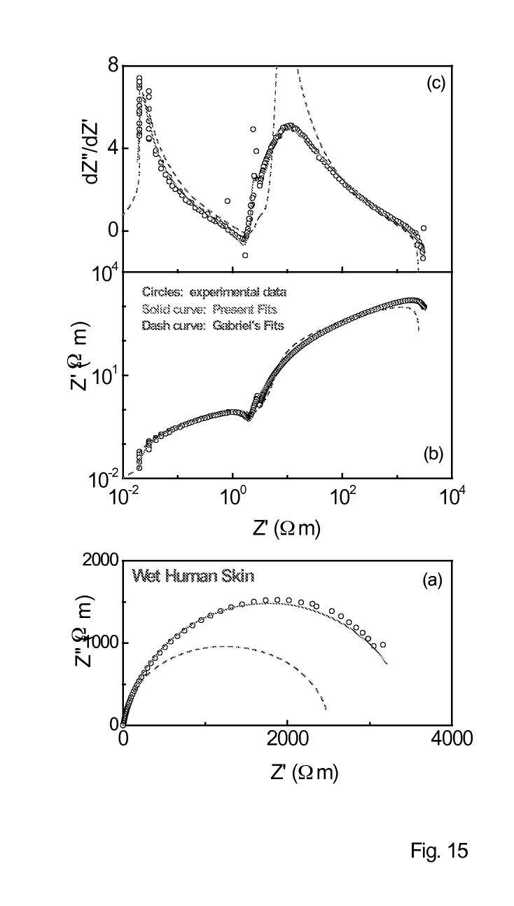

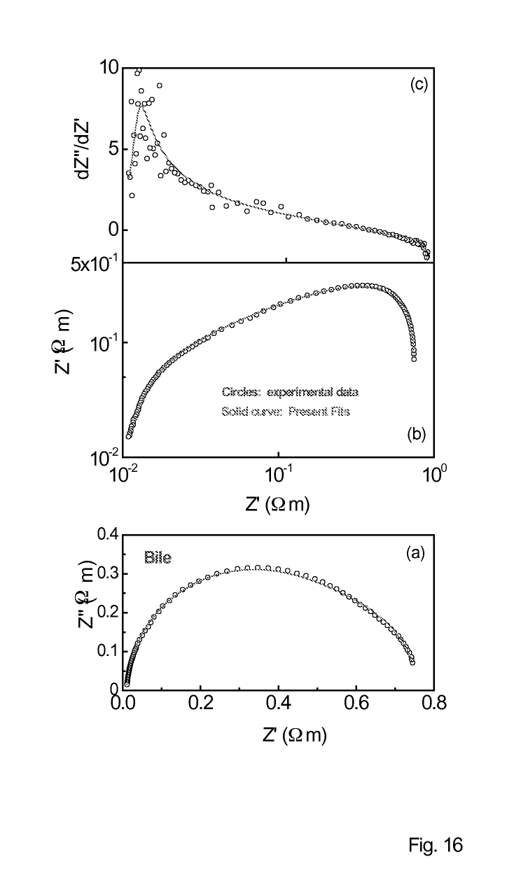

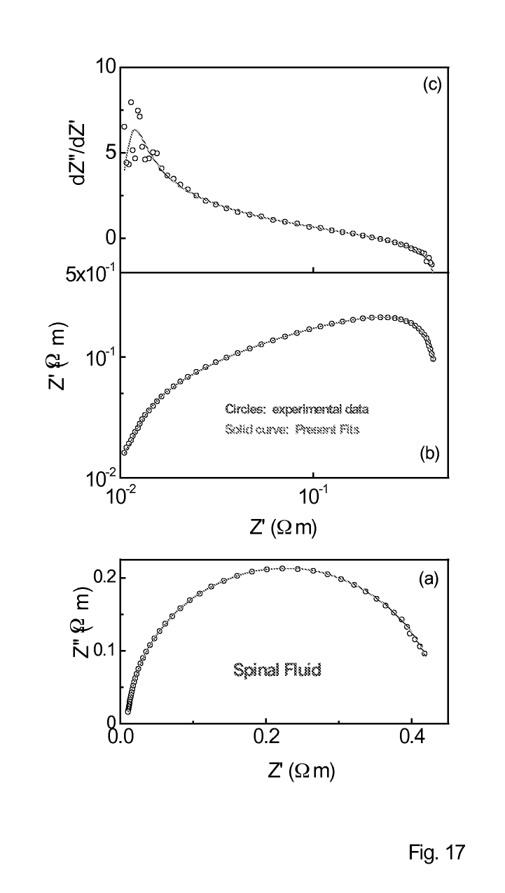

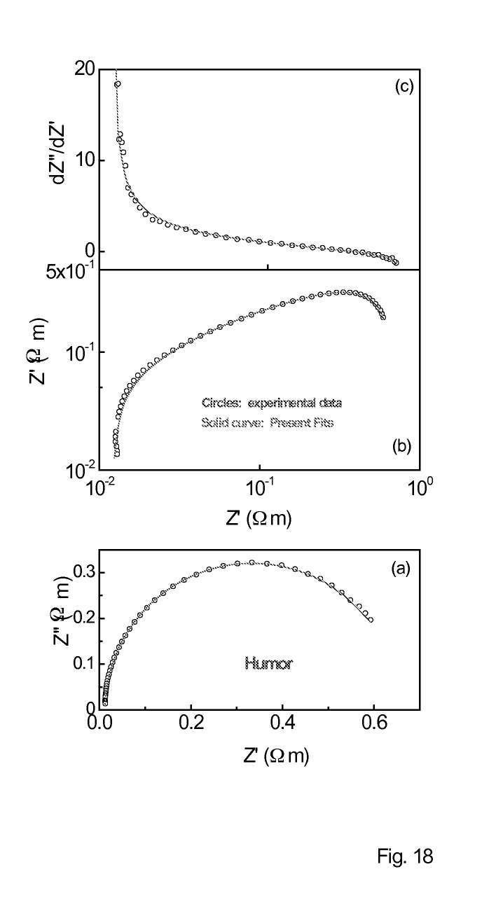

The examples 10-16 are results obtained using our methods for analyzing the electrical properties of ovine blood, bovine liver, bovine heart, wet human skin, bladder-bile, cerebral spinal-fluid, and vitreous humor; the fitting results are plotted in FIGS. 12-18. The fitting results obtained by Gabriel et al.' method are also plotted for comparison. It can be seen that all fits using our method provide excellent agreement with the experimental data (see, the experimental data of S. Gabriel, et al., downloaded from websites: http://www.brooks.af.mil/AFRL/HED/hedr/reports/dielectric/home.html., and http://niremf.ifac.enr.it/tissprop/). The parameters are listed in Table 1 shown in FIG. 10.

Discussion for CIS Results:

After solving the CIS spectrum according to Eq. (6), we obtain parameters C (capacitance) and R (resistance) for each solved semicircle—like arc, because Z′=R/(1+ω²C²R²) and Z″=ωCR²/(1+ω²C²R²). Then we can get the data for the corresponding dielectric permittivity ε and resistivity ρ.

We found: Semicircle 1 with resistivity ρ₁=0.011-0.018 Ωm (˜90-55 S/m) and ε₁=13-27 (time constant τ₁=˜2-3 ps, τ=ρεε₀=RC) can be clearly attributed to the biological water. The ρ₁and ε values mainly reflect the ionic conduction and dielectric polarization of water in the tissues at very high frequencies (˜10 GHz), respectively. Obviously, the high conductivity reflects the good conduction of the biological water at tens GHz, which generally contain ions, Na⁺, K⁺, C⁺⁺, OH⁻, etc.

Semicircle 2 with ρ₂=0.43-1.62 Ωm (˜2.3-0.6 S/m) and ε₂=˜55-72 (τ₂=274-856 ps) can also be attributed to biological water. For example, for semicircle 2, ρ₂=0.64 Ωm (with ε₂=70.9 and τ₂=402 ps), and ρ₂=0.43 Ωm (with ε₂=72.0 and τ₂=274 ps) are for the vitreous humor and cerebrospinal fluid, respectively. We know that 99% of the humor and spinal fluid are biological water (see, http://en.wikipedia.org/wiki/Vitreous_humour), therefore, semicircle 2 must be from the biological water of the tissues. But it should be pointed out that this occurs at ˜10⁸ Hz, including the contribution from both water and the solid phase of tissues. For example, semicircle 2 of the ovine blood with ρ₂=0.52 Ωm (τ₂=319 ps, and ε₂=65.8) can be attributed to plasma, as this value is in rough agreement with the resistivity of blood plasma of 0.66 Ωm reported in the literature (see, L. Geddes and L. E. Baker, The specific resistance of biological material-a compendium of data for the biomedical engineer and physiologist, Med. Biol. Engng., 5, (1967) 271; and N. Nandi and B. Bagchi, Dielectric relaxation of biological water, J. Phys. Chem., B101, (1997) 10954). But it is obvious that the difference in the resistivity (conductivity) and the dielectric constant may reflect the difference in the water content and other factors.

In addition to semicircles 1 & 2, there are more semicircles in some tissues at lower frequencies. Their biological meanings can be further revealed by combining information from both CPS and CIS.

### Further Discussion: Combination of CIS and CPS:

### Further Discussions of Skin

Different from other tissues, the specialty of skin is its laminar structure. The outermost layer of skin is the epidermis, which also possesses a multi-layer structure, including the stratum corneum layer, granular layer, basal layer, etc. Semicircles 1 & 2 of CIS and CPS were already discussed above; in the following, we focus on the discussion of semicircles 3-5.

Semicircle 5 of CIS has ε₅=1150 (and ρ₅=5720 Ωm) and ε₅=5.3×10⁴ (and ρ₅=3520 Ωm) for dry and wet human skin, respectively; we found that these correspond to semicircle 5 of CPS with Δε₅=1124 of dry skin and Δε₅=6.2×10⁴ of wet skin. Semicircle 4 of CIS has parameters of ε₄=4.7×10⁴ for wet skin; which corresponds to semicircle 4 of CPS with Δε₄=1.2×10⁴ for wet skin. Semicircle 3 of CIS has parameters of ε₃=492 (with ρ₃=1.4 Ωm) and ε₃=3039 (with ρ₃=0.42 Ωm) for dry and wet skins, respectively; which correspond to semicircle 4 of CPS with Δε₃=407 for dry skin and Δε₄=2510 for wet skin.

However, semicircle 3 (with Δε₃=647 and τ₃=23 ns) of CPS of dry skin, and one of semicircle 4 (with Δε₄=2.0×10⁴ and τ₄=1.2 μs) of CPS of wet skin, do not have counterparts in CIS. What is the reason? It is known that a semicircle of CIS can be explained to reflect the equivalent electrical circuit of a tissue component. The very high resistivity of semicircle 5 of CIS of skin must come from a non-conducting layer, i.e., the stratum corneum layer of epidermis. The decrease in resistivity from 5720 for dry skin to 3520 Ωm for wet skin is due to the absorption of more water.

We suppose that the semicircles next to semicircle 5 represent the layer next to the stratum corneum layer for wet or dry skins, respectively; considering the big difference in resistivity of the two layers in Table 1 shown in FIG. 10, an interfacial polarization is expected. Using a simple two-layer model, according to Eqs.(39) and (40) in the paper (see, K. R. Foster and H. P. Schwan, Dielectric properties of tissues and biological materials: a critical review, Critical Reviews in Biological Engineering, 17, (1989) 25), we simply supposed that there is the same thickness of the stratum corneum layer and the next layer of the skin, then we can obtain Δε=1600 with τ=20 ns for dry skin, and Δε=1.8×10⁴ with τ=6.4 μs for wet skin. These are what we observed in CPS, i.e., semicircle 3 of dry skin with Δε₃=647 and τ₃=23 ns and one of semicircle 4 of wet skin with Δε₄=2.0×10⁴ and τ₄=1.2 μs.

The above results for human skin show that CIS and CPS do reveal the laminar structure of skins, and provide the dielectric constant and resistivity of different layers. The change in the electrical properties of skins after absorbing water can also be clearly detected. A further detailed analysis of the parameters is being conducted.

In addition, it is noted that the sum of the resistivity of semicircles 1-4 of CIS is 2.69 Ωm and 3.67 for dry and wet skin, respectively, which corresponds to the resistivity range of 2.55-3.55 Ωm reported in the literature for skin (see, T. J. Faes, H. A. van der Meij, J. C. De Munck, R. M. Heethaar, The dielectric resistivity of human tissues (100 Hz -10 MHz): a meta-analysis of review studies, Physiol. Meas., 20, (1999) R1-10). This indicates that the data in the literature exclude the contribution of the stratum corneum layer.

### Relationship Between CIS and CPS

The above results for skin show that the semicircles 3-5 of CIS can find their counterparts in CPS. We find that an approximate corresponding relationship does exist in the tissues studied in the present work. For example, CIS for the heart has Δ₃=1626 (ρ₃=0.91 Ωm), ε₄ₐ=3.8×10⁴ 1626 (ρ₄ₐ=6.7 Ωm), ε_{4b}=6.3×10⁵ (ρ_{4b}=2.5 Ωm) and ε₅=9.2×10⁷ (ρ₅=9.8 Ωm), these roughly correspond to the semicircles of CPS with Δε₃=1580, Δε₄ₐ=1.6×10⁴, Δε_{4b}=1.4×10⁵, and Δε₅=2.8×10⁷. All data can be seen in Table 1 shown in FIG. 10.

As mentioned above, a semicircle of CIS corresponds to a component of the tissue. On the other hand, a semicircle of CPS reflects a polarization relaxation process, which generally comes from a component, or a relaxation mechanism (for example, an interfacial polarization), etc. The corresponding relationship between CIS and CPS (semicircles 3-5 at low frequencies) implies that the component of tissues detected by CIS has just one polarization relaxation process, which can be detected by CPS. The data from both CIS and CPS provides more reliable and complete information of a tissue component.

### Water Content of Tissues

Semicircle 1 of CPS and semicircles 1 & 2 of CIS both come from biological water. The combination of CPS and CIS can provide more information on tissue water.

### DC Conductivity

It is found that the total resistivity of all semicircles from CIS correspond to the dc conductivity vi obtained from the fit of CPS. For example, dry skin has a total resistivity of ˜5723 Ωm (the conductivity is of 1.75×10⁻⁴ S/m) from CIS, which is conductivity of 0.175 mS/m obtained by differentiating CPS.

The derivative/logarithmic circle spectra method developed in this work provides a unique advantage in differentiating and analyzing CPS and CIS. The application of the method to human skin, ovine blood, etc. confirms its success.

In addition, angular circle spectrum, i.e, θ (tan θ=−dε″/dε′ or −dZ″/dZ′) versus ε′ and/or Z′, can be also used to fit data, which provides similar advantage as the derivative circle spectrum does.

What we claim is:

1. A method to precisely differentiate the heavily overlapped electrical properties (electrical impedance or dielectric permittivity) measured from a system (a biological tissue, a body, a material, or a device, etc.).
The details are (numbers (a)-(b) do not indicate the order of the steps),
(a) converting the electrical properties into complex-permittivity (real and imaginary parts ε′ and ε″) and complex-impedance (real and imaginary parts Z′ and Z″) data;
(b) converting and plotting the ε′ versus ε″, and Z′ versus Z″ data into log ε″-log ε′, and log Z″-log Z′ data, i.e., logarithmic-logarithmic scale (spectrum).
(c) c converting and plotting the ε′ versus ε″, and. Z′ versus Z″ data into the slope dε″/dε′ versus ε′, and dZ″/dZ′ versus Z′ data, i.e., derivative circle spectrum.
(d) converting and plotting the ε′ versus ε″, and Z′ versus Z″ data into θ (tan θ=−dε″/dε′) versus ε′, and θ (tan θ=−dZ″/dZ′) versus Z′ data, i.e., angular circle spectrum. 9

2. A method according to claim 1,
(a) followed by numerical fitting of the derivative circle spectrum and/or angular circle spectrum for both CPS and CIS, according to Eq. (5) and (6), using a program (for example, a commercial software, Excel); then the electrical parameters, such as Δε, ε_{∞}, τ, σ, and α for CPS, and ρ (corresponding to R), ε (corresponding to C), τ, and α for CIS, can be obtained. The results can be converted, and plotted in a log-log scale for additional check of fitting accuracy.
(b) based on the parameters obtained, from both CPS and CIS, we can obtain useful information and reasonable interpretation of the electrical properties of a system.
